(19) United States
(12) Patent Application Publication
(10) Pub. No.: US 2015/0135912 A1
(43) Pub. Date: May 21, 2015

(54) Portable Skateboard Installation and Removal Device

(71) Applicant: Xingqing Ma, Huizhou (CN)

(72) Inventor: Xingqing Ma, Huizhou (CN)

(21) Appl. No.: 14/083,614

(22) Filed: Nov. 19, 2013

(51) Int. Cl. B25B 23/00; B25B 15/00; A63C 17/00; B25B 13/06

(52) U.S. Cl. CPC B25B 23/0007; B25B 13/06; B25B 15/005; A63C 17/0006
USPC 81/437

(57) ABSTRACT

A portable skateboard installation and removal device is disclosed. The device includes: a two-head sleeve, a single-head sleeve, and an L-shaped spanner with a long arm and a short arm. The two-head sleeve is hollow, and with the single-head sleeve inserted therein. A first through hole extends transversely through one end of the two-head sleeve. A second through hole extends transversely through one end of the single-head sleeve. The short arm of the L-shaped spanner is adapted to be inserted into the first through hole and the second through hole such that the two-head sleeve, the single-head sleeve and the L-shaped spanner are assembled together. It is nice in appearance, easy for use, and convenient for carrying with.

### FIELD OF THE INVENTION

This disclosure relates generally to an installation and removal device, and more particularly to a portable skateboard installation and removal device.

### BACKGROUND OF THE INVENTION

Skateboarding was probably born in 1950s from the surfing, and now has become a cool game popular with young people.

The skateboarding is normally performed outdoors. When people use the skateboard, a portable installation tool with small volume is usually provided. The installation tool consists of a screwdriver and a bearing assembling tool. The installation tool can only assemble some screws, but not all of the parts. Therefore, there is a need to provide a portable skateboard installation and removal device that is more convenient for carrying and with multiple functions.

### SUMMARY OF THE INVENTION

Thus, it is an object of this disclosure to provide a portable skateboard installation and removal device that is more convenient for carrying and with multiple functions.

To achieve the above object, a portable skateboard installation and removal device includes: a two-head sleeve, a single-head sleeve, and an L-shaped spanner with a long arm and a short arm. The two-head sleeve is hollow, and with the single-head sleeve inserted therein. A first through hole extends transversely through one end of the two-head sleeve. A second through hole extends transversely through one end of the single-head sleeve. The short arm of the L-shaped spanner is adapted to be inserted into the first through hole and the second through hole such that the two-head sleeve, the single-head sleeve and the L-shaped spanner are assembled together.

Preferably, both ends of the two-head sleeve are provided with a hexagonal socket.

Preferably, the single-head sleeve may be provided with a hexagonal socket at one end, and an external hexagonal screwdriver at the other end.

Preferably, a third through hole extends transversely through the middle of the two-head sleeve. The third through hole is hexagonal and with a dimension matching with that of the external hexagonal screwdriver.

Preferably, the third through hole is vertical to the first through hole.

Preferably, one end of the L-shaped spanner on the long arm is provided with a cross screwdriver, and the other end of the L-shaped spanner on the short arm is provided with an external hexagonal screwdriver.

Preferably, the two-head sleeve has a through hole with a sink hole. A T-shaped magnet is mounted in the through hole. One end of the T-shaped magnet is in contact with the single-head sleeve, and the other end of the T-shaped magnet is in contact with the L-shaped spanner.

The advantages of this disclosure are as follows:

1. It can realize the installation and removal of the parts of skateboard.

2. 4.8 grade medium carbon steel is normally used in the prior art, while in this disclosure, 8.8 grade medium carbon steel is used.

3. The installation and removal device of this disclosure has more functions, and will not increase the volume.

4. It is easy for people to carry with, especially for those people who often adjust the skateboard.

### BRIEF DESCRIPTION OF THE DRAWINGS

FIG. 1 is a schematic view showing a portable skateboard installation and removal device according to one embodiment of this disclosure.

FIG. 2 is a schematic view showing an exploded state of a portable skateboard.

FIG. 3 is a schematic view showing a working state of a portable skateboard.

Wherein:

10. Two-head sleeve; 11. Hexagonal socket; 12. First through hole; 14. Third through hole; 16. Through hole; 20. Single-head sleeve; 24. Hexagonal socket; 242. Second through hole; 26. External hexagonal screwdriver; 30. L-shaped spanner; 32. External hexagonal screwdriver; 34. Cross screwdriver; 40. Magnet.

### DETAILED DESCRIPTION OF THE PREFERRED EMBODIMENTS

Reference will now be made in detail to exemplary embodiments of the invention, which are illustrated in the accompanying drawings.

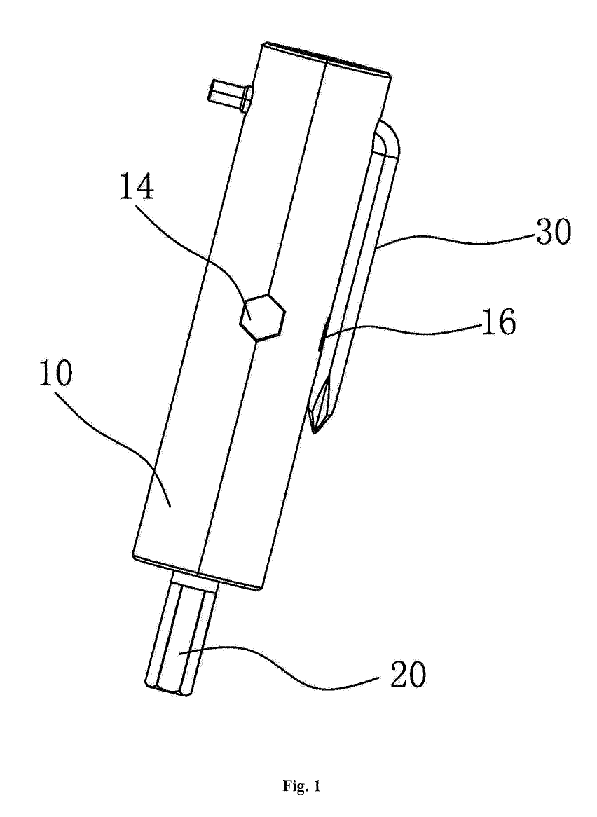

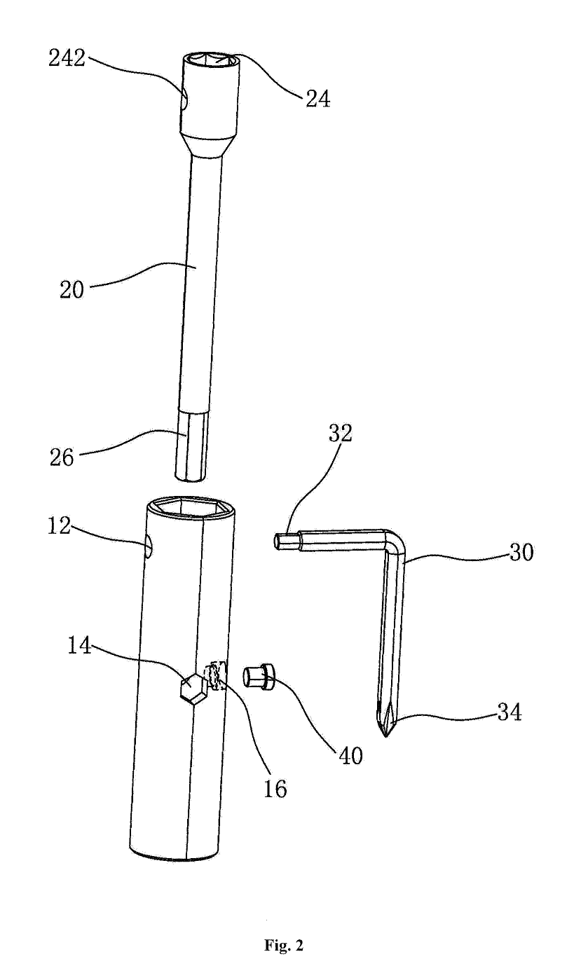

Referring to FIGS. 1 and 2, a portable skateboard installation and removal device includes: a two-head sleeve 10, a single-head sleeve 20, and an L-shaped spanner 30 with a long arm and a short arm. The two-head sleeve 10 is hollow, and with the single-head sleeve 20 inserted therein. A first through hole 12 extends transversely through one end of the two-head sleeve 10. A second through hole 242 extends transversely through one end of the single-head sleeve 20. The short arm of the L-shaped spanner 30 is adapted to be inserted into the first through hole 12 and the second through hole 242 such that the two-head sleeve 242, the single-head sleeve 20 and the L-shaped spanner 10 are assembled together.

Both ends of the two-head sleeve 10 are provided with a hexagonal socket. The single-head sleeve 20 may be provided with a hexagonal socket at one end, and an external hexagonal screwdriver 26 at the other end.

A third through hole 14 may extend transversely through the middle of the two-head sleeve 10. The third through hole 14 is hexagonal and with a dimension matching with that of the external hexagonal screwdriver 26. The third through hole 14 is vertical to the first through hole 12.

One end of the L-shaped spanner 30 on the long arm is provided with a cross screwdriver 32, and the other end of the L-shaped spanner on the short arm is provided with an external hexagonal screwdriver 24.

The two-head sleeve 10 has a through hole 16 with a sink hole. A T-shaped magnet 40 is mounted in the through hole 16. One end of the T-shaped magnet 40 is in contact with the single-head sleeve 20, and the other end of the T-shaped magnet is in contact with the L-shaped spanner 30.

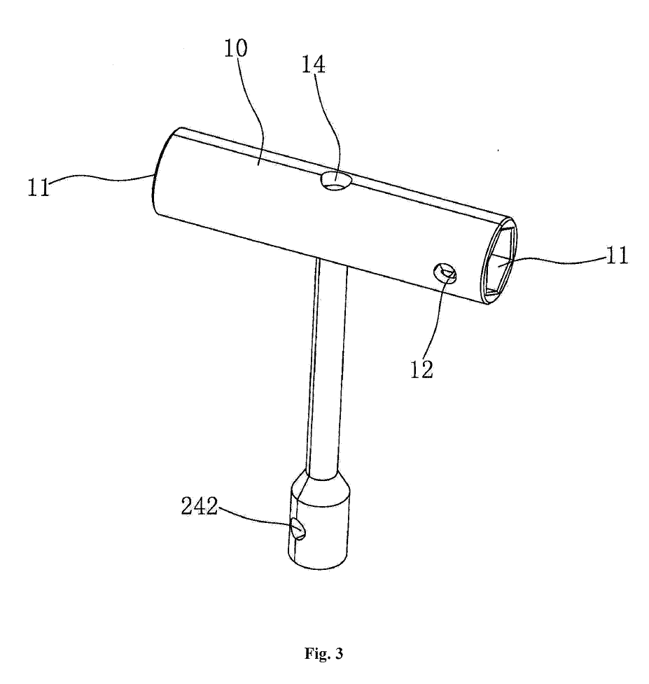

Referring to FIGS. 1 to 3, when the device is not in use, the two-head sleeve 10, the single-head sleeve 20 and the L-shaped sleeve 30 can be assembled together for easy carrying. For installation and removal, one end of the L-shaped spanner 30 may be an ⅛ inch external hexagonal screwdriver, and the other end of the L-shaped spanner 30 may be a cross screwdriver 34. One end of the single-head sleeve 20 may be a ⅜ inch hexagonal socket for installing and removing nuts on the skateboard, and the other end may be a ¼ inch external hexagonal screwdriver 26 which may be inserted into the two-head sleeve 10.

In this embodiment, the single-head sleeve 20 can be inserted into the two-head sleeve 10, and assembled together by the L-shaped spanner 30. In this way, it saves space and is easy for carrying with when skateboarding outdoors. Furthermore, with the magnet mounted on the two-head sleeve, the single-head sleeve and the L-shaped spanner will not be easily released. It is thus nice in appearance, easy for use, and convenient for carrying with.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A portable skateboard installation and removal device, comprising:
a two-head sleeve;
a single-head sleeve; and
an L-shaped spanner with a long arm and a short arm;
wherein the two-head sleeve is hollow, and with the single-head sleeve inserted therein; a first through hole extends transversely through one end of the two-head sleeve; a second through hole extends transversely through one end of the single-head sleeve; the short arm of the L-shaped spanner is adapted to be inserted into the first through hole and the second through hole such that the two-head sleeve, the single-head sleeve and the L-shaped spanner are assembled together.

2. The device of claim 1, wherein both ends of the two-head sleeve are provided with a hexagonal socket.

3. The device of claim 1, wherein the single-head sleeve is provided with a hexagonal socket at one end, and an external hexagonal screwdriver at the other end.

4. The device of claim 3, wherein a third through hole extends transversely through the middle of the two-head sleeve; the third through hole is hexagonal and with a dimension matching with that of the external hexagonal screwdriver.

5. The device of claim 4, wherein the third through hole is vertical to the first through hole.

6. The device of claim 1, wherein one end of the L-shaped spanner on the long arm is provided with a cross screwdriver, and the other end of the L-shaped spanner on the short arm is provided with an external hexagonal screwdriver.

7. The device of claim 1, wherein the two-head sleeve has a through hole with a sink hole; a T-shaped magnet is mounted in the through hole; one end of the T-shaped magnet is in contact with the single-head sleeve, and the other end of the T-shaped magnet is in contact with the L-shaped spanner.
